(19) United States
(12) Patent Application Publication
(10) Pub. No.: US 2026/0098815 A1
(43) Pub. Date: Apr. 9, 2026

(54) DEFECT CLASSIFICATION METHOD, ANALYSIS METHOD, AND INSPECTION APPARATUS

(71) Applicant: Lasertec Corporation, Yokohama (JP)

(72) Inventors: Shota FUJIKI, Yokohama-shi (JP); Yoshito OZAKI, Yokohama-shi (JP)

(21) Appl. No.: 19/354,267

(22) Filed: Oct. 9, 2025

(30) Foreign Application Priority Data
Oct. 9, 2024 (JP) 2024-176871

(51) Int. Cl. G01N 21/88; G01N 21/64

(52) U.S. Cl. CPC G01N 21/8851; G01N 21/6489; G01N 2021/8854

(57) ABSTRACT

A defect classification method includes: projecting an illumination beam toward the silicon carbide substrate and scanning a position at which the silicon carbide substrate is illuminated with the illumination beam; detecting reflected light and photoluminescence light including light in a visible region, emitted from the silicon carbide substrate; and classifying the defects based on a result of the detection of the reflected light and a result of the detection of the photoluminescence light including the light in the visible region, in which the classifying the defects includes classifying the defect as a 3C-SF (Stacking Fault) based on detection of a first defect image by the reflected light and classifying the defect as an SSF (Shockley-type Stacking Fault) based on detection of a second defect image by the photoluminescence light including the light in the visible region.

### INCORPORATION BY REFERENCE

This application is based upon and claims the benefit of priority from Japanese patent application No. 2024-176871, filed on October 09, 2024, the disclosure of which is incorporated herein in its entirety by reference for all purposes.

### BACKGROUND

The present disclosure relates to a defect classification method, an analysis method, and an inspection apparatus.

A wafer in which silicon carbide (hereinafter also referred to as SiC) is homoepitaxially grown on a SiC wafer is used as a power semiconductor. Epitaxial films are used as drift layers of devices. It has been known that a crystal defect present in such an epitaxial film layer causes a defect in the device, but not all crystal defects cause a defect in the device, i.e., only specific types of crystal defects cause a defect in the device.

### [Patent Literature 1] Japanese Patent No. 5633099

### SUMMARY

An inspection using a filter for a near-infrared region which lets photoluminescence (hereinafter also referred to as PL) light emitted from a basal plane dislocation (hereinafter also referred to as BPD), which causes a killer defect, pass therethrough is known. However, there is a need for a technology or the like for accurately detecting stacking faults and classifying detected stacking faults.

The present disclosure has been made in view of these problems, and provides a defect classification method, an analysis method, and an inspection apparatus capable of improving the accuracy of the classification of defects including stacking faults in a SiC substrate.

A defect classification method according to an aspect of an embodiment is a defect classification method for classifying defects present in a silicon carbide substrate into a plurality of types, including: projecting an illumination beam toward the silicon carbide substrate and scanning a position at which the silicon carbide substrate is illuminated with the illumination beam; detecting reflected light and photoluminescence light including light in a visible region, emitted from the silicon carbide substrate; and classifying the defects based on a result of the detection of the reflected light and a result of the detection of the photoluminescence light including the light in the visible region, in which the classifying the defects includes classifying the defect as a 3C-SF (Stacking Fault) based on detection of a first defect image by the reflected light and classifying the defect as an SSF (Shockley-type Stacking Fault) based on detection of a second defect image by the photoluminescence light including the light in the visible region.

An analysis method according to an aspect of an embodiment is a method for analyzing a defect present in a silicon carbide substrate, including: projecting an illumination beam toward the silicon carbide substrate and scanning a position at which the silicon carbide substrate is illuminated with the illumination beam; detecting photoluminescence light including at least light in a visible region and light in an infrared region, emitted from the silicon carbide substrate; and analyzing a cause of an occurrence of an SSF (Shockley-type Stacking Fault) based on a result of detection of the photoluminescence light in the visible region and a result of detection of the photoluminescence light in the infrared region.

An inspection apparatus according to an aspect of an embodiment is an inspection apparatus configured to classify defects present in a silicon carbide substrate into a plurality of types, including: illumination means for projecting an illumination beam toward the silicon carbide substrate; scanning means for scanning a position at which the silicon carbide substrate is illuminated with the illumination beam; light detection means for detecting reflected light and photoluminescence light including light in a visible region, emitted from the silicon carbide substrate; and classification means for classifying the defects based on a result of the detection of the reflected light and a result of the detection of the photoluminescence light including the light in the visible region, in which the classification means classifies the defect as a 3C-SF (Stacking Fault) based on detection of a first defect image by the reflected light and classifying the defect as an SSF (Shockley-type Stacking Fault) based on detection of a second defect image by the photoluminescence light including the light in the visible region.

An inspection apparatus according to an aspect of an embodiment is an inspection apparatus configured to analyze a defect present in a silicon carbide substrate, including: illumination means for projecting an illumination beam toward the silicon carbide substrate; scanning means for scanning a position at which the silicon carbide substrate is illuminated with the illumination beam; detection means for detecting photoluminescence light including at least light in a visible region and light in an infrared region, emitted from the silicon carbide substrate; and analysis means for analyzing a cause of an occurrence of an SSF (Shockley-type Stacking Fault) based on a result of detection of the photoluminescence light in the visible region and a result of detection of the photoluminescence light in the infrared region.

According to the present disclosure, it is possible to provide a defect classification method, an analysis method, and an inspection apparatus capable of improving the accuracy of the classification of defects including stacking faults in a SiC substrate.

The above and other objects, features and advantages of the present disclosure will become more fully understood from the detailed description given hereinbelow and the accompanying drawings.

### BRIEF DESCRIPTION OF DRAWINGS

FIG. 1 is a diagram for explaining a configuration of a light source apparatus according to a first embodiment;

FIG. 2 is a diagram for explaining a configuration of a signal processing apparatus according to the first embodiment;

FIG. 3 is a diagram for explaining an example of a method for classifying SSFs;

FIG. 4 is a diagram for explaining an SSF caused by a BPD;

FIG. 5 is a flowchart for explaining a defect classification method according to the first embodiment;

FIG. 6 is a diagram for explaining an example of an inspection apparatus for carrying out a defect classification method according to a second embodiment; and

FIG. 7 is a flowchart for explaining the defect classification method according to the second embodiment.

### DESCRIPTION OF EMBODIMENTS

Embodiments according to the present disclosure will be described hereinafter with reference to the drawings. The following description shows embodiments according to the present disclosure, and the scope of the present disclosure is not limited to the below-shown embodiments. In the following description, components/structures assigned the same reference numerals are substantially similar to each other.

### First Embodiment

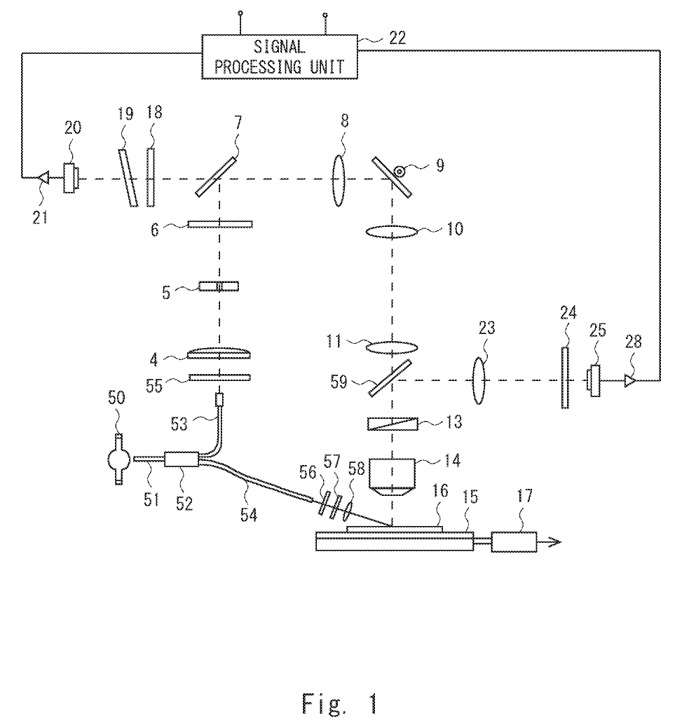

FIG. 1 shows an example of an inspection apparatus for carrying out a defect classification method according to a first embodiment. In this example, by using a confocal scanning apparatus including a differential interference optical system, the entire surface of a SiC substrate to be inspected is scanned; reflected light and PL light emitted from the SiC substrate are individually detected; and a reflected-light inspection and a PL-light inspection are performed in parallel. A SiC substrate including an epitaxial layer formed thereon is used as an object to be inspected, and defects formed in the epitaxial layer are detected and classified. Note that a SiC substrate including no epitaxial layer formed thereon is also used as an object to be inspected. The SiC substrate may be a 4H-SiC substrate.

In this example, a first illumination system for forming a reflection image and a second illumination system for forming a PL image are used. In the first illumination system, the surface of a substrate is scanned by using an illumination beam in a visible region, and in the second illumination system, the surface of the substrate is scanned by using an illumination beam in an ultraviolet region. The first and second illumination beams illuminate the same point on the SiC substrate.

In this example, the reflected-light inspection is performed by using a mercury xenon lamp as an illumination light source 50, and using a visible light having a wavelength of 546 nm emitted from the mercury xenon lamp as the illumination beam of the first illumination system. Further, the PL-light inspection is performed by using an ultraviolet light having a wavelength of 313 nm as the illumination beam of the second illumination system. The light beam emitted from the illumination light source 50 propagates through a first optical fiber 51. An optical fiber coupler 52 is coupled to the emission end of the first optical fiber. Second and third optical fibers 53 and 54 are coupled to the emission side of the optical fiber coupler 52. The optical beam is divided into two beams by the optical fiber coupler 52. Then, one of the beams propagates through the second optical fiber 53 and is used for the reflected-light inspection, while the other beam propagates through the third optical fiber 54 and is used for the PL-light inspection. Note that separate light sources each of which emits light are prepared as a light source for emitting light used for the reflected-light inspection and a light source for emitting light used for the PL-light inspection, respectively. In this case, the inspection apparatus does not need to include the optical fiber coupler 52.

The light beam emitted from the second optical fiber 53 enters a filter 55 that lets light having a wavelength of 546 nm pass therethrough (that transmits light having a wavelength of 546 nm), so that a first illumination beam having a wavelength of 546 nm exits from the filter 55. The light beam, which has exited from the third optical fiber 54, passes through a filter 56 that lets light having a wavelength of 313 nm pass therethrough, and enters a polarizer 57. The polarizer 57 receives the light beam and emits a P-polarized light beam. Therefore, a second illumination beam having a wavelength of 313 nm, which has been P-polarized, is emitted from the polarizer 57. The second illumination beam passes through a focusing lens 58 and is projected toward a SiC substrate 16 as a converging illumination beam.

The second illumination system projects the P-polarized illumination beam toward the SiC substrate 16 at an incident angle equal to a Brewster angle. Therefore, the optical axes of the third optical fiber 54, the filter 56, the polarizer 57, and the lens 58, which constitute the second illumination system, are aligned at an angle equal to the Brewster angle. When the P-polarized illumination beam is projected at the incident angle equal to the Brewster angle, the reflected light becomes substantially zero, so that most of the illumination beam incident on the SiC substrate 16 enters the SiC substrate 16. Therefore, PL light having higher intensity can be generated, and a clear PL image is thereby formed. As a result, the accuracy of the detection of a defect image is increased, so that an advantage that defects are accurately classified is achieved.

The first illumination beam exiting from the filter 55 is converted into a parallel beam by a condensing lens 4, and enters a slit 5. The slit 5 is disposed at the pupil position of the lens 4, and has a slender opening extending in a first direction (a direction perpendicular to the paper surface). Note that the first direction is referred to as an X-direction. The width of the opening of the slit 5 is set to, for example, 10 to 20 μm. Therefore, a slender line-shaped light beam extending in the first direction is emitted from the slit 5. The line-shaped light beam emitted from the slit 5 enters a polarizer 6 and is converted into polarized light having a single plane of vibration (hereinafter also referred to as a vibration plane). This line-shaped polarized light beam is reflected by a half-silvered mirror 7, which functions as a beam splitter, and then passes through a lens 8 and enters a vibrating mirror 9, which functions as a scanning device.

When the surface image of the SiC substrate 16 is reviewed, the vibrating mirror 9 functions as a beam scanning device that deflects the illumination beam in a second direction (Y-direction) perpendicular to the first direction. The entire surface of the SiC substrate 16 is scanned by two dimensional movements of a stage 15, which supports the SiC substrate 16, during the inspection, so that the vibrating mirror 9 functions as a total reflection mirror during the inspection. The line-shaped light beam emitted from the vibrating mirror 9 passes through lenses 10 and 11 and enters a dichroic mirror 59. The dichroic mirror 59 performs a function for separating the reflected light and the PL light emitted from the SiC substrate 16. Therefore, for example, a dichroic mirror that lets light having a wavelength of 546 nm ±20 nm pass therethrough and reflects light having other wavelengths is used. The illumination beam, which passed through the dichroic mirror 59, enters a Nomarski prism 13. In this example, the Nomarski prism 13 is used as a differential interference optical system. The line-shaped illumination beam, which has entered the Nomarski prism 13, is converted into two sub-beams whose vibration planes are perpendicular to each other. These two sub-beams have a phase difference expressed as (2m+1)π/2 therebetween, where m is a natural number. Therefore, a defect having a height change of several nanometers formed on the surface of the SiC substrate 16 can be detected as a light/dark luminance image. Further, the shirring amount of the Nomarski prism 13 is set to, for example, 2 μm. Note that the Nomarski prism 13 is detachably disposed in the optical path, so that it is inserted into the optical path when a confocal differential interference image of the SiC substrate 16 is taken, and is removed from the optical path at all other times, for example, when a three-dimensional confocal image of the SiC substrate 16 is taken or a surface contour image of the SiC substrate 16 is taken.

The two sub-beams exiting from the Nomarski prism 13 enter an objective lens 14. The objective lens 14 converges the two line-shaped sub-beams, which have entered therein, and projects them toward the SiC substrate 16 disposed on the stage 15. In this example, a SiC substrate 16 including an epitaxial layer formed thereon is used as a substrate to be inspected, and defects present in the epitaxial layer are detected. The stage 15 is formed by an XY-stage; its position information is detected by a position sensor 17; and the position information of the stage 15 is supplied to a signal processing unit 22. During the inspection, the stage 15 moves in the Y- and X-directions in a zigzag manner, so that the entire surface of the SiC substrate 16 is scanned by the illumination beam. Note that when a detected defect is reviewed by using the address of the defect, the stage is moved in the X- and Y-directions based on the coordinate information of the defect, and the defect is thereby moved into the field of view; and the vibrating mirror 9 is scanned in the second direction, so that a confocal differential interference image of the defect and its vicinity can be taken.

When a defect appears on the surface of the SiC substrate 16 as a concave/convex defect having a size of about several nanometers to several hundred nanometers, a phase difference corresponding to the height change of the defect is introduced between the two sub-beams reflected on the surface of the SiC substrate 16, so that two reflected sub-beams containing phase difference information corresponding to the height of the defect present on the surface of the SiC substrate 16 are formed. These two reflected sub-beams are concentrated by the objective lens 14 and enter the Nomarski prism 13. Then, the two reflected sub-beams are combined by the Nomarski prism 13, so that an interference beam containing the phase difference information indicating the height change on the surface of the SiC substrate 16 is formed. For example, when a concave or convex defect having a size of about several nanometers is present on the surface of the SiC substrate 16, one of the two sub-beams, which have been incident on the surface of the SiC substrate 16, scans the defect, and the other sub-beam scans the normal surface part, so that a phase difference corresponding to the height of the defect is introduced between the two sub-beams. As a result, the defect, which has appeared on the surface of the SiC substrate 16, is detected as a luminance image.

When a crystal defect is present inside the epitaxial layer of the SiC substrate 16, the second illumination beam, which is projected through the lens 58, passes through the surface of the SiC substrate 16, enters the SiC substrate 16, and is incident on the defect. When ultraviolet light is incident on the defect, PL light having a wavelength that varies according to the type of the defect is generated. According to IEC 63068-3 ANNEX B, the wavelength of PL light coming from a BPD (Basal Plane Dislocation), which is a type of defect of the SiC substrate 16, is about 700 nm. An SSF (Shockley-type Stacking Fault), which is another type of defect of the SiC substrate 16, is classified into one of 1SSF to 4SSF. The wavelength of PL light coming from 1SSF is about 420 nm. The wavelength of PL light coming from 2SSF is about 500 nm. The wavelength of PL light coming from 3SSF is about 480 nm. The wavelength of PL light coming from 4SSF is about 455 nm.

The reflected light and the PL light emitted from the SiC substrate 16 are concentrated by the objective lens 14, pass through the Nomarski prism 13, and enter the dichroic mirror 59. The dichroic mirror 59 lets light having a wavelength of 546 nm ±20 nm pass therethrough and reflects light having other wavelengths. Therefore, the PL light generated by a BPD or an SSF is reflected by the dichroic mirror 59. Meanwhile, the reflected light reflected on the surface of the SiC substrate 16 passes through the dichroic mirror 59.

The reflected light, which has passed through the dichroic mirror 59, passes through the lenses 11 and 10, is reflected by the vibrating mirror 9, and enters the lens 8. This lens 8 acts as an image-forming lens for the reflected light coming from the SiC substrate 16. The reflected light, which has passed through the lens 8, passes through the half-silvered mirror 7, passes through an analyzer 18 and a positioner 19, and enters first light detection means 20. In this example, the first light detection means 20 is formed by a line sensor. An image signal output from the line sensor, which serves as a photographing device, is supplied to the signal processing unit 22 through an amplifier 21.

The PL light reflected on the dichroic mirror 59 enters a filter 24 through a lens 23. The filter 24 lets light having wavelengths including a visible region and an infrared region pass therethrough. The infrared region means a wavelength range longer than 700 nm.

The filter 24 lets at least light having the wavelength of the PL light of the SSF and light having the wavelength of the PL light of the BPD. The light-emission intensity of the PL light coming from 1SSF, 2SSF, 3SSF, or 4SSF has a peak in a range of 420 to 500 nm, and the wavelength of the PL light coming from a BPD has a peak at about 700 nm. Therefore, the filter 24 is configured so as to let light having a wavelength of 400 to 520 nm and light having a wavelength of 680 nm or longer pass therethrough.

Second light detection means 25 is formed by a line sensor. An image signal output from the second light detection means 25 is supplied to the signal processing unit 22 through the amplifier 28.

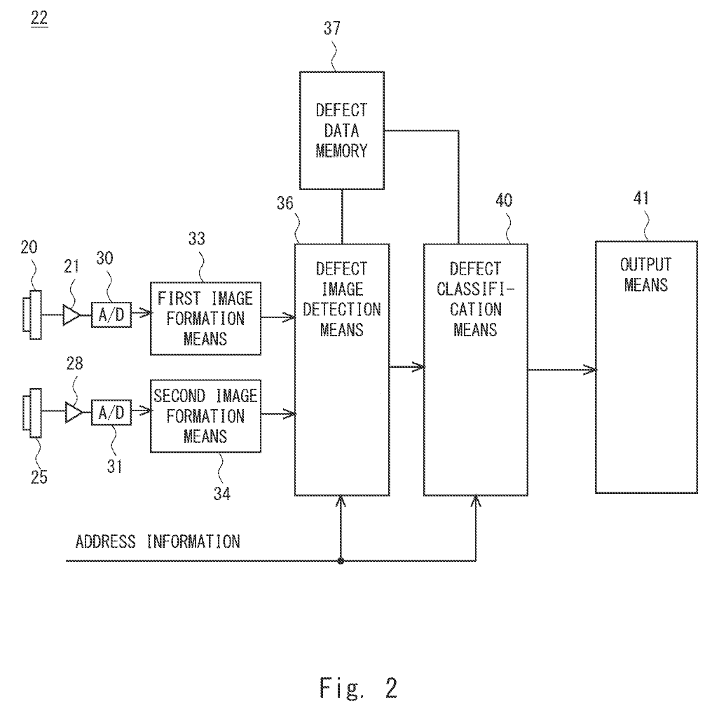

FIG. 2 shows an example of the signal processing unit 22. In this example, the detection of defects by a reflected-light inspection and the detection of defects by a PL-light inspection are performed in parallel, and the detected defects are classified based on the results of these inspections. Image signals output from the first and second light detection means 20 and 25 are supplied to and converted into digital signals in A/D converters 30 and 31, respectively.

An image signal output from the first light detection means 20 is supplied to first image formation means 33, and a two-dimensional image (reflection image) is formed by the reflected light. A second image signal output from the second light detection means 25 is supplied to second image formation means 34, and a two-dimensional image (PL image) is formed by the PL light including light in the visible region.

The reflection image signal and the PL image signal are supplied to defect image detection means 36. The defect image detection means 36 compares the supplied reflection image signal and the supplied PL image signal with a reference luminance value on a pixel-by-pixel basis, and forms a defect image by detecting pixels indicating luminance values outside the range of the reference luminance value. For example, a defect image is formed by mapping pixels outside the range of the reference luminance value. A defect image may be detected by mapping pixels in each of which an image signal having a luminance higher than a reference value is detected.

Address information indicating the position on the SiC substrate 16 at which the illumination beam is incident is also supplied to the defect image detection means 36. This address information may be determined by using the position information of the stage, which supports the SiC substrate 16, and information of each pixel in the first and second light detection means 20 and 25. The detected defect image is stored in a defect data memory 37 together with the address information. After the inspection over the entire surface of the SiC substrate 16 is completed, an operator can access the defect data memory 37 by using the address of a defect of interest, and thereby can display and observe the defect image on the monitor.

The detected defect image is supplied to defect classification means 40. When a triangular defect image is detected on the reflection image, the defect classification means 40 classifies this defect as a 3C-SF (also referred to as poly-inclusion). The defect classification means may classify the defect as a 3C-SF by taking account of the fact that a particle is present at the apex of the triangle.

The defect classification means 40 may classify a defect that appears as a triangular defect image on the reflection image and appears as a dark triangular defect image in the PL image as a 3C-SF. When the peak wavelength of PL light coming from a 3C-SF is not included in the transmission wavelength range of the filter 24, the defect image of the 3C-SF on the PL image becomes dark against the background.

When a bright triangular defect image is detected on the PL image, the defect classification means 40 classifies this defect as an SSF. The SSF includes 1SSF to 4SSF. Since the filter 24 lets PL light coming from an SSF pass therethrough, the defect image of the SSF on the PL image becomes bright against the background.

In the related art, since the filter 24 does not let PL light coming from an SSF, the SSF is detected as a dark triangular region. However, there is a problem that the detection accuracy is poor because the contrast is low. In the first embodiment, the filter 24 that lets PL light coming from an SSF pass therethrough is used, so that the accuracy of the detection of an SSF can be improved.

Note that when a defect image having a quadrangular shape (e.g., a trapezoid or a diamond shape) is detected on the PL image, the defect classification means 40 may classify this defect as an SSF. It has been known that a BPD may grow into an SSF, and in this case, a defect image having a quadrangular shape may be detected on the PL image. Since the contrast of the defect image is improved, the first embodiment can make it possible to detect an SSF originating from a BPD.

Although it is difficult to detect an SSF from a reflection image, the first embodiment can make it possible to detect an SSF by using a PL image. The defect classification means 40 may classify a defect as an SSF by taking into account the fact that a defect image indicating one side or two sides of a triangle is detected on the reflection image.

The defect classification means 40 may classify the SSF into 1SSF to 4SSF. The defect classification means 40 may classify the SSF into 1SSF to 4SSF based on the result of detection at each wavelength of the PL light.

The defect classification means 40 may classify the SSF into 1SSF to 4SSF based on, for example, the PL image at each wavelength. For example, a spectrum camera may be used as the second light detection means 25. Alternatively, it is possible to take a PL image at each wavelength by disposing a filter corresponding to the PL wavelength of one of 1SSF to 4SSF between the filter 24 and the second light detection means 25 shown in FIG. 1. Alternatively, the second light detection means 25 may be equipped with a prism or a color filter. In this way, the second light detection means 25 may take a color image, and an SSF may be classified into 1SSF to 4SSF based on the difference in color of each defect image.

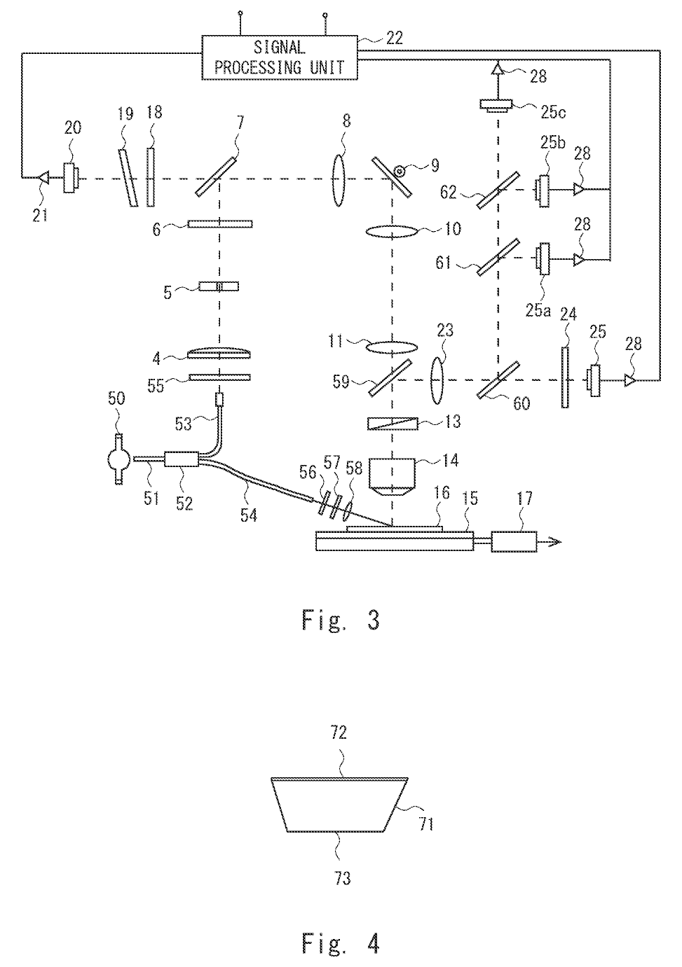

As shown in FIG. 3, the SSF can be classified into 1SSF to 4SSF by increasing the number of sensors. A dichroic mirror 60 lets light having a wavelength A or longer pass therethrough and reflects light having the wavelength A or shorter. The value A is set to, for example, a value larger than the PL wavelength of 3SSF (e.g., 480 nm) and smaller than the PL wavelength of 2SSF (e.g., 500 nm). In this case, an SSF detected by using the second light detection means 25 is classified as 2SSF. A dichroic mirror 61 lets light having a wavelength B or longer pass therethrough and reflects light having the wavelength B or shorter. The value B is set to, for example, a value larger than the PL wavelength of 1SSF (e.g., 420 nm) and smaller than the PL wavelength of 4SSF (e.g., 455 nm). An SSF detected by using the sensor 25a is classified as 1SSF. A filter that lets PL light coming from 1SSF pass therethrough may be disposed between the sensor 25a and the dichroic mirror 61. A dichroic mirror 62 lets light having a wavelength C or longer pass therethrough and reflects light having the wavelength C or shorter. The value C is set to, for example, a value larger than the PL wavelength of 4SSF (e.g., 455 nm) and smaller than the PL wavelength of 3SSF (e.g., 480 nm). An SSF detected by using the sensor 25b is classified as 4SSF. A filter that lets light coming from 4SSF pass therethrough may be disposed between the sensor 25b and the dichroic mirror 62. An SSF detected by using the sensor 25c is classified as 3SSF. A filter that lets light coming from 3SSF pass therethrough may be disposed between the sensor 25c and the dichroic mirror 62.

Referring to FIG. 2 again, when a bright line-shaped defect image is detected on the PL image, the defect classification means 40 classifies this defect as a BPD. Since the filter 24 lets the PL light coming from the BPD pass therethrough, the defect image of the BPD on the PL image becomes bright against the background.

The defect classification means 40 analyzes whether the defect classified as the SSF is an SSF originating from a BPD or an SSF generated during the epitaxial growth. That is, the defect classification means 40 classifies the detected defect as an SSF originating from a BPD or an SSF generated during the epitaxial growth. Specifically, the defect classification means 40 determines that a defect originates from a BPD when one side of a triangle or a quadrangle indicating a defect image of an SSF on the PL image is thicker than the other sides thereof.

According to this embodiment, it is possible to detect both a defect image classified as a BPD and a defect image classified as an SSF with high contrast. Based on this fact, referring to FIG. 4, a bright quadrangular (e.g., trapezoidal) defect image 71 is detected on the PL image, and one side 72 of the quadrangle is thicker than the other sides thereof. The quadrangular (e.g., trapezoidal) shape is a defect image detected based on the light having the PL wavelength of the SSF, and the thick side 72 is a line-shaped defect image detected based on the detection of the light having the PL wavelength of the BPD. It is considered that since the defect images overlap each other, the SSF is formed as the BPD present on the side 73 has moved toward the side 72. As described above, when one side of the shape of the defect image classified as an SSF is thicker than the other sides thereof, the defect classification means 40 determines that the SSF is generated by a BPD. In other words, when a defect image classified as a BPD is detected at a position corresponding to one side of the shape of a defect image classified as an SSF, the defect classification means 40 determines that this SSF is an SSF generated by a BPD. Note that although the description has been given by using quadrangular defect imaged as exampled, the same applies to a triangular defect image. That is, when a bright triangular defect image is detected on the PL image and one side of the triangle is thicker than the other sides thereof, the defect classification means 40 may determine that it is an SSF generated by a BPD.

Referring to FIG. 2 again, the defect classification means 40 may classify each defect based on the result of learning such as deep learning. The defect data memory 37 stores, for each defect image, defect data including a defect classification and an address of the defect image.

The defect classification is supplied to output means 41 together with the address information. An operator enters designation information specifying a defect type of interest and an occurrence state through an input device such as a keyboard.

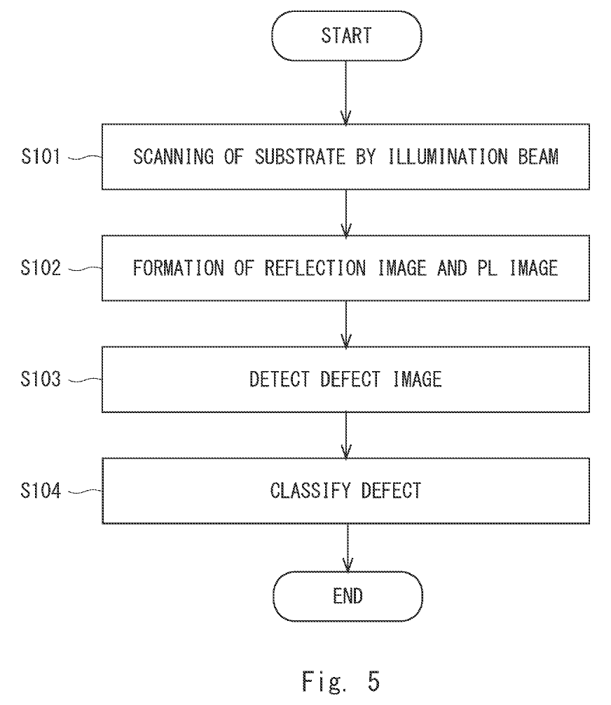

FIG. 5 is a flowchart showing a flow of a defect classification method according to the first embodiment. Firstly, the entire surface of a SiC substrate is scanned by using an illumination beam (Step S101). Then, reflected light and PL light emitted from the SiC substrate are individually detected, and a reflection image and a PL image are respectively formed (Step S102).

Defect images are detected by performing a reflected-light inspection on the formed reflection image. In parallel, defect images are also detected by performing a PL-light inspection on the PL image (Step S103).

Next, defects are classified based on the defect images (Step S104). For example, a defect is classified as 3C-SF based on the reflection image, and a defect is classified as an SSF based on the PL image.

In the step S104, the cause of the generation of the SSF may be analyzed. For example, when the defect image of the SSF includes a defect image corresponding to a BPD (when a defect image classified as a BPD is detected at a position corresponding to one side of the shape of the defect image classified as the SSF), it may be determined that the SSF is generated by the BPD.

The defect classification method according to the first embodiment can improve the accuracy of the classification of defects. Further, the defect classification method according to the first embodiment makes it possible to analyze the cause of the occurrence of the SSF.

### Second Embodiment

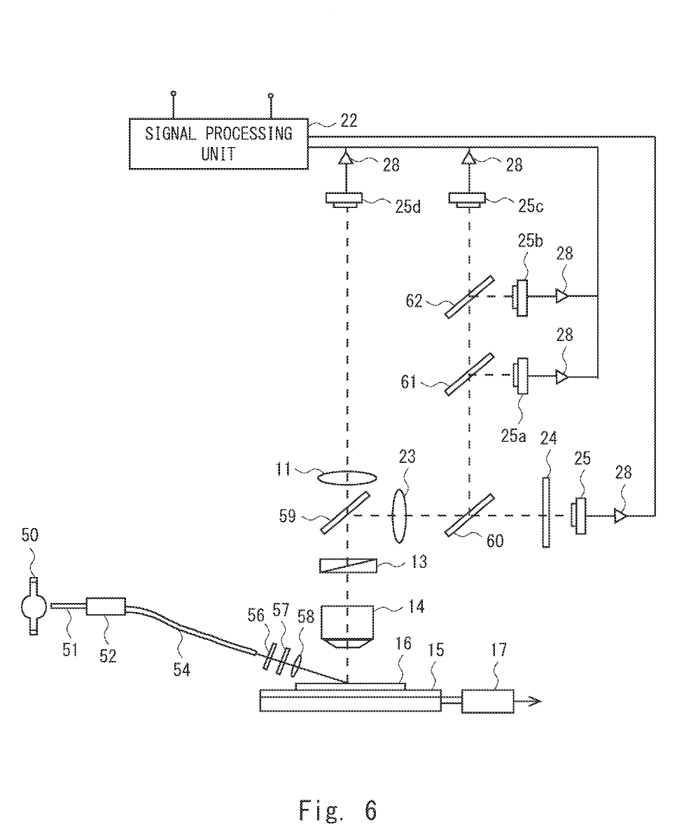

A second embodiment does not require the reflected-light inspection, and the PL-light inspection is mainly performed. FIG. 6 shows an example of an inspection apparatus for carrying out a defect classification method according to the second embodiment. When FIG. 3 and FIG. 6 are compared with each other, the inspection apparatus shown in FIG. 6 does not include the first illumination system for forming a reflection image. Note that as shown in FIG. 1, the inspection apparatus may not include the sensors 25a to 25d and include only the sensor 25.

The dichroic mirror 59 lets, for example, light having a wavelength of 700 nm or longer and reflects light having other wavelengths. When a bright line-shaped defect image is detected on the PL image based on an image signal output from the sensor 25d, the signal processing unit 22 classifies the defect as a BPD. Similarly to the first embodiment, when a bright triangular or quadrangular defect is detected on the PL image based on image signals output from the sensors 25, 25a, 25b, and 25c, the signal processing unit 22 classifies the defects as 2SSF, 1SSF, 4SSF, and 3SSF, respectively.

When a defect image classified as a BPD is detected at a position corresponding to one side of the shape of a defect image classified as one of 1SSF to 4SSF, the signal processing unit 22 determines that the SSF is an SSF generated by a BPD. Alternatively, when one side of a defect image classified as an SSF is thicker than the other sides thereof, the signal processing unit 22 may determine that the SSF is an SSF generated by a BPD.

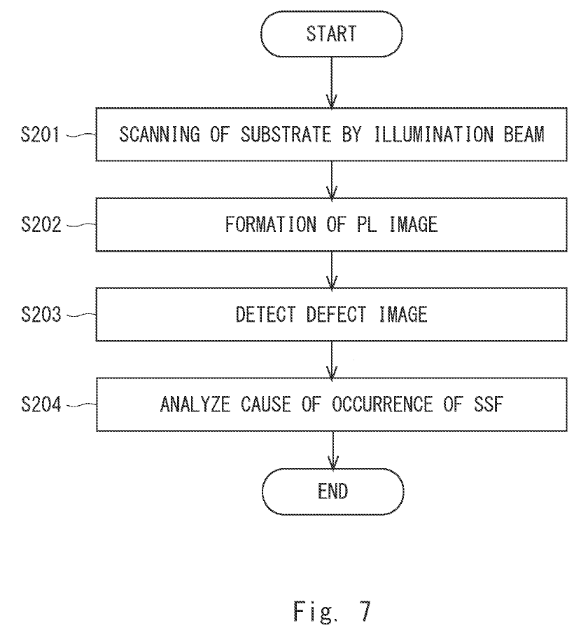

FIG. 7 is a flowchart showing a flow of a defect classification method according to the second embodiment. Firstly, the entire surface of a SiC substrate is scanned by using an illumination beam (step S201). Then, PL light emitted from the SiC substrate is detected, and a PL image is formed (Step S202). Defect images are detected by performing a PL-light inspection on the PL image (Step S203). Next, the cause of the occurrence of the SSF is analyzed based on the defect image (Step S204). Specifically, the signal processing unit 22 determines whether or not the SSF is generated by a BPD.

The defect classification method according to the second embodiment makes it possible to analyze the cause of the generation of the SSF.

Although embodiments according to the present disclosure have been described above, the present disclosure includes modifications that do not impair the objects and advantages of the disclosure and is not limited by the above-described embodiments. Further, combinations of the configurations of the first and second embodiments also fall within the scope of the technical idea of the present disclosure.

The first and second embodiments can be combined as desirable by one of ordinary skill in the art.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A defect classification method for classifying defects present in a silicon carbide substrate into a plurality of types, comprising:
projecting an illumination beam toward the silicon carbide substrate and scanning a position at which the silicon carbide substrate is illuminated with the illumination beam;
detecting reflected light and photoluminescence light including light in a visible region, emitted from the silicon carbide substrate; and
classifying the defects based on a result of the detection of the reflected light and a result of the detection of the photoluminescence light including the light in the visible region,
wherein the classifying the defects includes classifying the defect as a 3C-SF (Stacking Fault) based on detection of a first defect image by the reflected light and classifying the defect as an SSF (Shockley-type Stacking Fault) based on detection of a second defect image by the photoluminescence light including the light in the visible region.

2. The defect classification method according to claim 1, wherein the classifying the defects includes classifying the SSF into one of 1SSF to 4SSF based on a result of detection at each wavelength of the photoluminescence light.

3. The defect classification method according to claim 1, wherein the classifying the defects includes classifying the defect as a BPD (Basal Plane Dislocation) based on a result of detection of photoluminescence light in an infrared region.

4. An analysis method for analyzing a defect present in a silicon carbide substrate, comprising:
projecting an illumination beam toward the silicon carbide substrate and scanning a position at which the silicon carbide substrate is illuminated with the illumination beam;
detecting photoluminescence light including at least light in a visible region and light in an infrared region, emitted from the silicon carbide substrate; and
analyzing a cause of an occurrence of an SSF (Shockley-type Stacking Fault) based on a result of detection of the photoluminescence light in the visible region and a result of detection of the photoluminescence light in the infrared region.

5. The analysis method according to claim 4, wherein the analyzing the cause of the occurrence includes determining that an SSF is caused by a BPD when one side of a shape of a defect image classified as the SSF is thicker than other sides thereof.

6. The analysis method according to claim 4, wherein the analyzing the cause of the occurrence includes determining that an SSF is caused by a BPD when a defect image classified as a BPD is detected at a position corresponding to one side of a shape of a defect image classified as the SSF.

7. The analysis method according to claim 4, further comprising classifying defects in the silicon carbide substrate as a BPD (Basal Plane Dislocation) based on a result of detection of the photoluminescence light in the infrared region.

8. The analysis method according to claim 4, further comprising classifying the SSF into 1SSF to 4SSF based on a result of detection at each wavelength of the photoluminescence light in the visible region.

9. An inspection apparatus configured to classify defects present in a silicon carbide substrate into a plurality of types, the inspection apparatus comprising:
one or more illumination systems configured to project an illumination beam toward the silicon carbide substrate;
one or more detectors configured to detect reflected light and photoluminescence light including light in a visible region, emitted from the silicon carbide substrate;
one or more processors; and
a memory storing instructions that, when executed by the one or more processors, cause the inspection apparatus to:
control scanning of a position at which the silicon carbide substrate is illuminated with the illumination beam; and
classify the defects based on a result of detection of the reflected light and a result of detection of the photoluminescence light including the light in the visible region,
wherein the classification includes:
classifying the defect as a 3C-SF (Stacking Fault) based on detection of a first defect image by the reflected light; and
classifying the defect as an SSF (Shockley-type Stacking Fault) based on detection of a second defect image by the photoluminescence light including the light in the visible region.

10. An inspection apparatus configured to analyze a defect present in a silicon carbide substrate, the inspection apparatus comprising:
one or more illumination systems configured to project an illumination beam toward the silicon carbide substrate;
one or more detectors configured to detect photoluminescence light including at least light in a visible region and light in an infrared region, emitted from the silicon carbide substrate;
one or more processors; and
a memory storing instructions that, when executed by the one or more processors, cause the inspection apparatus to:
control scanning of a position at which the silicon carbide substrate is illuminated with the illumination beam; and
analyze a cause of an occurrence of an SSF (Shockley-type Stacking Fault) based on a result of detection of the photoluminescence light in the visible region and a result of detection of the photoluminescence light in the infrared region.
